(19) United States
(12) Patent Application Publication
(10) Pub. No.: US 2005/0289453 A1
(43) Pub. Date: Dec. 29, 2005

(54) Apparatys and method for off-line synchronized capturing and reviewing notes and presentations

(76) Inventors: Tsakhi Segal, Cupertino, CA (US); Liel Biran, Kfar Saba (IL); Giora Feldman, Tel Aviv (IL); Guy Krikheli, Or Yehuda (IL)

Correspondence Address: GLENN PATENT GROUP, 3475 EDISON WAY, SUITE L, MENLO PARK, CA, 94025, US

(21) Appl. No.: 11/158,663

(22) Filed: Jun. 21, 2005

Related U.S. Application Data
(63) Continuation-in-part of application No. 10/977,257, filed on Oct. 28, 2004.
(60) Provisional application No. 60/580,706, filed on Jun. 21, 2004.

(51) Int. Cl. G06F 17/00; G06F 15/00

(52) U.S. Cl. 715/512; 715/541; 715/500.1; 715/730

(57) ABSTRACT

The application and method disclosed herein teach the capturing of notes in synchronization to a presentation, or any other form of message delivery, that enables a synchronized review between the presentation and notes made thereof. A synchronization between a presenter's and a note taker's clocks through a time server allows for the off-line note taking using a plurality of note taking devices while maintaining synchronization. Due to this off-line synchronization between a presentation and notes taken thereof it is possible to locate both the note taken at a certain time in the presentation and vice versa, making notes relevant to a portion of the presentation when they were taken.

### CROSS REFERENCE TO RELATED APPLICATIONS

This application is a continuation-in-part of U.S. patent application Ser. No. 10/977,257, filed on Oct. 28, 2004, and also claims priority to U.S. provisional application 60/580,706, filed Jun. 21, 2004, each of which is incorporated herein in its entirety by this reference thereto.

### BACKGROUND OF THE INVENTION

1. Technical Field

The invention relates generally to the field of presentation and note-taking by participants in presentations. More particularly, the invention relates to the synchronization of note-taking with a presentation.

2. Discussion of the Prior Art

Students and corporate employees commonly engage in writing notes during presentations, e.g. during classes or meetings. Notes, which may take the form of written text, drawings, shorthand symbols, and, others serve the purpose of enhancing memory recall and of documenting the class or meeting. Notes may be reviewed later on for many uses including, for example, preparation for exams or follow-up meetings, and to research or act upon information conveyed in the presentation. Typically, such notes provide a way for a participant in a presentation to summarize important points and indicate subject matter that requires further research or action.

Despite the note-taker's intentions, notes often prove to be of limited use. This is especially true of hard-copy notes on paper, which are difficult to access and search.

However, even when using modern computer applications that specialize in note storage and retrieval, the usability of notes is limited due to loss of context. A note that may have made perfect sense within the context of a presentation often seems meaningless after several days or weeks have passed and crucial information connecting the note to the content of the presentation is not readily accessible. The cause of this problem is that notes are collected and stored by participants on personal media, whether hard-copy or computer based, that is not usually associated with a recorded rendition of the presentation, either because it is not recorded at all or because the recording is not readily accessible.

One practical solution is to record presentations, for instance as online multimedia content, such as those produced by means disclosed in U.S. Pat. No. 6,388,654, Method and Apparatus for Processing, Displaying and Communicating Images (hereinafter the “Tegrity Software Application” or “TSA”) assigned to a common assignee and which is herein incorporated by this reference thereto for all that it contains.

It is possible to provide access to such recordings, allowing participants to play back a selected presentation while reviewing the relevant notes made in a paper notebook or note-storing computer application. The main drawback of this approach is the lack of direct access between a note taken during a presentation and the location on the multimedia content that pertains to that location. To locate the portion of a presentation pertaining to a particular note, one must spend time locating the correct recording e.g. tape, CD, link, or other media, and then search for the appropriate segment within it by, for example, playing back the recording sequentially, perhaps skipping forward or backward until the desired portion is found. Similarly, while playing back a portion of a recorded presentation, there is no easy way to locate and identify the notes originally made at that point in the presentation. When using shorthand symbols or abbreviated markings, context may be irrecoverably lost once human memory of the event and the cause for making the notation fades. At the extreme, this could require a participant to review the entire recorded presentation to recapture the meaning of a single shorthand note that was made while attending the original event. The same drawback applies to new notes that may be made subsequently during sequential reviews of such recordings.

Certain prior art solutions suggest that a system be made where note taking is done while the note taking devices are kept in constant synchronization with the presentation, i.e. the presenter's computer as well as the note takers' note taking devices are all on line and fully synchronized with the presenter's presentation. This requires network connectivity at all times for all computerized note taking devices, significantly limiting the practicality of such systems.

It would be therefore advantageous to provide a method and apparatus for note taking that is synchronized with a presentation without requiring active network connectivity while note taking takes place.

### SUMMARY OF THE INVENTION

The application and method disclosed herein teach the capturing of notes in synchronization to a presentation, or any other form of message delivery, that enables a synchronized review between the presentation and notes made thereof. A synchronization between a presenter's and a note taker's clocks through a time server allows for the off-line note taking using a plurality of note taking devices while maintaining synchronization. Due to this off-line synchronization between a presentation and notes taken thereof it is possible to locate both the note taken at a certain time in the presentation and vice versa, making notes relevant to a portion of the presentation when they were taken.

### BRIEF DESCRIPTION OF THE DRAWINGS

FIG. 1 illustrates a presentation as it appears on a page of a note taker's notebook application according to the invention;

FIG. 2 illustrates notes written by a note taker on a notebook page that are both adjacent to and overlapping an image imported into a notebook application, as well as annotations made by a presenter according to the invention;

FIG. 3 illustrates a notebook page that contains an imported slide-image along with note taker notes and an iconic indication inserted by the note taker according to the invention;

FIG. 4 shows a notebook application side-by-side with a presentation viewing application as seen during review after a presentation where playback is positioned two seconds into the presentation according to the invention;

FIG. 5 illustrates presentation of FIG. 4 after playback has shifted 30 seconds to 0:32 as a result of activating indexed playback on a selected iconic indication according to the invention;

FIG. 6 illustrates the presentation of FIG. 4 with notes highlighting during playback shifted an additional 33 seconds to 0:55 according to the invention;

FIG. 7 is a flowchart showing a method for capturing notes and arranging them according to the invention;

FIG. 8 is a block schematic diagram of an apparatus to the invention;

FIG. 9 is a flowchart showing a clock synchronization process according to the invention;

FIG. 10 is a flowchart showing the synchronization of the note-taking device clock to a reference clock according to the invention;

FIG. 11 is a detailed flowchart showing synchronization of the note-taking device clock to a reference clock according to the invention; and

FIG. 12 is a flowchart related to enabling a click on a digital page for the purpose of note and presentation correlation according to the invention.

### DETAILED DESCRIPTION OF THE INVENTION

The following terms are used throughout this disclosure. Unless explicitly noted otherwise, wherever these terms are used they refer to the meanings assigned below:

Presentation—a class lecture, meeting, training session, or any human interaction convened for the purpose of conveying information. A presentation comprises a presenter and one or more note takers (defined below). Each presentation captured for use with a deployment of this invention is assigned a unique ID to distinguish it from other collocated presentations.

Presenter—the person or persons conveying presentation information to others in a presentation. The presenter may comprise one or more individuals at any given time and presenters may change or alternate during the presentation.

Presentation information—any material that is referenced or linked to the presentation and that can be accessed electronically, including, but not limited to, verbal or otherwise audible information (audio), visual information (video), notes, slides or other images, at which the presenter may point, computer applications, textbooks, articles, and web pages.

Note taker (or Participant)—an individual attending a presentation with the intent of obtaining information. A note taker may be physically present at the site where the presentation takes place or may attend via means of communication from a remote site. A note taker may also become a presenter during a portion of a presentation, or throughout the presentation may be a presenter.

Notes—information entered by a note taker into an application, for example, a computer application with data entry capabilities, such information pertaining to a presentation. The information may be entered to the application, on-line or off-line, by means that include, but are not limited to, handwritten digital ink, text, selectable predefined symbols (icons), images, or any other computer-based object that may be inserted in a application.

Notebook application (or notebook)—a computer software application that provides capabilities for entering notes. Typically, a notebook includes many features that aid in organizing, entering, and reviewing notes for personal use, such as multiple sections, multiple notebook files, options for inserting and formatting notes, options for selecting notes to copy, move, delete, or reformat them, and more. Regardless of additional hierarchical organization that may be available, the notebook's most basic working area is referred to as a page, where each page may contain multiple notes. The precise boundaries of a page depend on the specific notebook application, and may be based on a fixed or modifiable display size or may be determined by explicit actions of the user, e.g. via “add/insert page” functionality. For the purposes of this description, a notebook section is a logical unit of information in which the notes for a single presentation are kept. Depending on the notebook application, each section may be implemented as a separate data file or container, as a hierarchical construct within a single notebook container, or only as a logical entity based on assigning a section attribute or tag internal to the notebook application. The invention may be implemented to work with various distinct notebook applications running on desktop and portable computing devices, including portable computers, handheld devices, such as Palm Pilot® and Pocket PC®, or any device capable of supporting such applications. Examples of existing notebook applications include products from the Microsoft Office® suite and Internet browser applications that support plug-in modules and extensions which may add notebook functionality.

Synchronous—happening at real-time. When referring to a presentation this indicates that the note takers receive information from the presenter as it is conveyed during the presentation, possibly with a small delay. Note takers may be physically present at the same site as the presenter or in remote locations, but they are communicating in the same time frame.

Asynchronous—not synchronous. When referring to a presentation this indicates that note takers receive information from the presenter after it has been conveyed, perhaps long after the presentation is over. This is accomplished by playing back a recorded rendition of the presentation by some means. The note taker may be at any location during asynchronous playback.

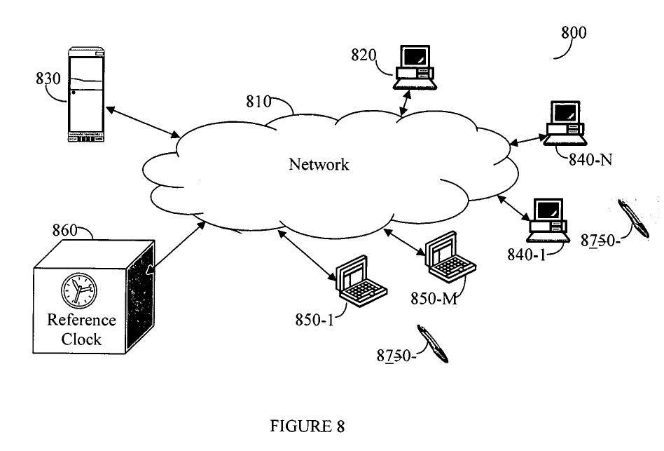

The invention comprises an apparatus and method for enhancing the process of capturing and reviewing notes by note takers during presentations, to provide for more efficient information retrieval and to facilitate more effective learning. The invention may be further understood in conjunction with the system 800 shown in FIG. 8, which is an exemplary and non-limiting system for the realization of the disclosed invention. A goal of the invention is to provide note takers, for example those note takers using notebooks and other handheld devices 850-1 through 850-M, and note takers using computers, for example computers 840-1 through 840-N, with means to create useful notes regardless of whether they are physically present at the presentation. The presentation is made by a presenter using, for example, a computer 820. The note takers may alternatively be at remote locations, as made possible by connectivity with a network 810. Notes may be taken regardless of whether the notes are taken before the presentation in preparation, during the presentation, or after the presentation while performing a review, for example by means of downloading the presentation, or otherwise viewing the presentation, from a server 830.

Note taking in accordance with the invention is synchronized to a presentation regardless of the connectivity of the device used to enter the notes, i.e. it may be on-line or off-line, while assuring note synchronization with the presentation. Namely, physical synchronization is performed only periodically, while at all other times at least devices 840 and 850 may be off-line. While the presenter is shown using computer 820, it is within the scope of the invention for the presenter to use other devices that are capable of synchronization in the manner disclosed herein, including but not limited to a voice recorder device or an audio-video recorder with a synchronized clock. The presenter may later import the recorded audio to a computer, subsequently generating the Tegrity software application (TSA) presentation that is later viewed by the note takers. In this case, there may be only audio or audio-video playback possibly while showing a slide containing general information about the presentation.

The computer 820 or other device used by the presenter may likewise be either on-line or off-line during the presentation, while assuring synchronization with notes taken by note takers. Physical synchronization may be performed only periodically. On-line connectivity is normally required at certain times for the purposes of publishing presentation information to be accessed by note takers, however not necessarily during the presentation. System 800 may further comprise of a plurality of note-taking devices (NTDs), for example NTDs 870-1 through 870-K. NTDs may communicate in an on-line or off-line mode with any one of computers 840 or 850. The function of NTDs 870 is explained in further detail below.

Another goal of the invention is to allow note takers to use existing industry-standard note-taking hardware and software applications for any or all of their notes, while providing the enhanced capabilities afforded by the invention in connection with a subset of presentations i.e. those that are recorded according to the invention.

The invention may be implemented to empower a given notebook application with the functionality described herein, in addition to its own native functionality. An advantage of the invention is that the notebook application can be a commonly available, industry-standard software product, which note takers might be expected to use on a daily or periodic basis for much or all of their note-taking tasks, including presentations that do not make use of the current invention. It may also operate with specialized notebook applications developed to support hardware platforms for which no suitable standard applications exist.

Furthermore, the invention makes it possible to take notes before, during, and after the presentation in synchronization to the presentation, but without requiring a continued connection. This is accomplished in accordance with the disclosed invention by periodically synchronizing at least the note taking device and the presenter's device to a standard clock, for example a time-server 860, and thereafter maintaining a clock in reference to the standard clock, for the presentation as well as the note taking, as described in more detail below. The time-server 860 may be, for example, one of the time-servers available for access through the WorldWide Web. A time-server maintains a globally accurate time and external systems can access this information using a special Internet protocol, such as a network time protocol (NTP), or a simple network time protocol (SNTP), or the time-server may comprise a server configured to provide the information using a hyper text transfer protocol (HTTP). The time-server 860 can be also a specific designated computer including a reference clock.

For a given application, for example a notebook application, the invention can be implemented by at least one software module that interacts with the notebook application and with one or more other applications, including multimedia presentation and control tools. Henceforth, these software modules are referred to collectively as the notes module. The notes module may compare plug-ins, add-ins, or various types of executables, whether integrated with the notebook application or external to it. The notes module may interact with the notebook application by means of facilities built-in to that application, such as macros, or add-ins that execute in the context of the application. Alternatively, in the case of external modules, they may use software hooks offered by the underlying operating system or low-level drivers e.g. mouse and keyboard device drivers or display memory, to analyze activity and deduce what note-taking or control actions are required, based on what the note taker has done. Interaction with other, tools i.e. presentation tools and control tools, can be implemented by various forms of inter-process communication within the same computer or over a network.

The notes module may also interact with external devices that collect or manage notes. This interaction includes, but is not limited to, communicating with such devices over wired or wireless communication channels and transferring data from and/or to the devices. This facilitates importing notes that were previously or concurrently collected by a note-taking device, exporting notes to a remote device, or exchanging management information about notes. As a non-limiting example, the Mobile Note Taker® device by Pegasus Technologies Ltd. may be used to collect and store a digital copy of handwritten notes while being written on paper with a pen. Other non-limiting examples of NTDs are the Anoto® digital pen and the Logitech® io Digital Pen. These devices use a specialized digital paper. Although scribbling on the digital paper is performed using regular ink, the digital paper incorporates an irregular grid of tiny dots. These dots allow an optical sensor in the digital pen to do identify the location of the pen as strokes are written, the respective information of which is stored in the pen's memory. Each page of digital paper can be uniquely identified by the dot patterns within it. This allows the digital pen to detect and store the association of each stroke that it captures to a specific, uniquely identified page. A page may also be part of a paper notebook. These notes can be imported into the notes application in real-time, i.e. while being written, or at a later time by connecting the device to a computer. The connection event activates software that is capable of extracting the digital note information, e.g. point data and time values, and converting the information to the same internal representation as that which is used for notes entered using other means. It should be noted that while the note-taking device described herein is generally for the purpose of capturing handwriting marks, the scope of the use of NTDs should not be viewed as limited to devices of this type. Specifically, devices such as audio capture, video capture, for example by means of a Web camera or any other type of capturing device pertinent or contributing to note-taking, generally referred to as multi-media NTDs (MM-NTDs), are specifically included within the scope of the disclosed invention.

The notes module can also supply user-interface elements, such as toolbars, buttons, dialog boxes, data-entry fields, formatted displays, and more to support the functions described herein and to allow the user to adapt, tune, or customize specific aspects of behavior. The user interfaces may be implemented with any of a great variety of appearances and options using well-known techniques.

In a presently preferred embodiment of the invention the notes module comprises VisualBasic add-in components and loaded executable files (DLLs) developed to work with Microsoft Office® products. In addition, to support some handheld devices, e.g. Palm Pilot®, Mobile Note Taker®, a specialized notebook application can be used with facilities to import and export pertinent data to another computer. In one embodiment of the disclosed invention it is necessary to synchronize the note-taking device's clock to a reference clock. The reference clock is discussed in detail both above, for system 800, and below, specifically for the note-taking device. It is necessary to synchronize these clocks to ensure that note-taking captured by the note-taking device, preferably when in off-line mode of operation, is essentially synchronized with at least a reference clock.

In preparation for a presentation, the presenter may publish material in the form of digital media, such as slides or documents, making them available to note takers via email, digital storage media, online, e.g. Internet or intranet over a network 810, through an organizational learning management system (LMS), or by other means. Note takers may subsequently insert this material as one or more objects in their notebook application. This allows them to prepare for the presentation and may also serve as a background for note-taking before, during, or after the presentation by annotating over the objects visible in the notebook. This capability consists of locating the published material, selecting the objects to insert and inserting them in the notebook, and optionally resizing or reformatting their visual appearance. If a presenter plans to use a computer-based presentation application, for example on computer 820, to capture and stream or broadcast content from the presentation over a network, for example a network 810, using multimedia technologies, the material published by the presenter could also include a link or location at which note takers are able to access the presentation for online viewing when it occurs.

The note taker acquires published material through the notes module, which offers a user-interface that the note taker uses to browse to the location of the published material, to view a list of the material that the presenter has published, and to choose which items to insert in the notebook. If no material was formerly inserted into the notebook for this presentation, a new notebook section associated with the specific presentation may be automatically generated. Alternative ways of associating notebook sections and presentations are discussed below. Inserted items may be basic object types that conform to native formats of the notebook application: typical examples are images or text. They may also be of more complex forms, which may be implemented as, for example, Windows® COM or plug-in objects. Display formatting options for various types of objects are typically provided by the hosting notebook application, for example on a notebook 840 or a computer 850, and can be readily supplemented.

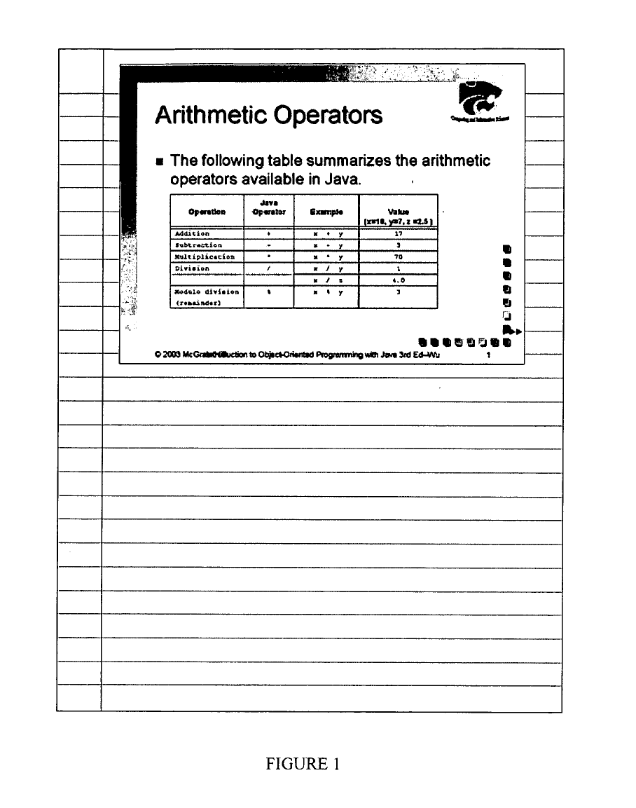

In one embodiment of the invention, the presenter uses the TSA to broadcast and record the presentation. In this case, the presenter uses an upload option offered by the TSA prior to the presentation to store a link on a server computer, along with media and other files associated with the planned presentation, such as a collection of slides and more. Note takers can access this link over the network to obtain relevant data in advance of or during, the presentation and to view the presentation once it begins. FIG. 1 provides an example of how such information may appear in a note taker's notebook once imported. FIG. 1 shows the image of a slide inserted at the top portion of an empty page.

The acquisition of presentation materials can also be used to provide the note taker's notebook and notes module with general information about the presentation, such as title, name of presenter, organizational information, scheduling information and more. These items are stored in association with the appropriate notebook section for presentation. This information may be useful to the note taker and may aid, for example, in organizing notebooks, automatically starting the note-taking application at a scheduled time, and providing additional context for reviewed notes, as described later on.

The events of starting and ending a presentation are relevant in two regards. The first is associating a specific presentation with the corresponding notebook section or notes object in the notebook of each note taker, and the second is in synchronizing clocks. The specific options available to note takers depend mainly on network connectivity and whether or not a presentation capture tool is used. Note takers that are connected to a network, e.g. via wireless access, can benefit from automatic start/stop and synchronization with a presentation capture tool. This can be accomplished by communicating the event (start, stop) to the notes module, which modifies the notebook section. For a start event the modules creates a new section, if necessary, and associates it with the presentation being started by a unique presentation ID generated by the presentation capture system. For a stop event, the modules close the section. The start event can also set a presentation base-time value to be used in conjunction with time stamping all subsequent events for this presentation. Typically, the note taker is asked to confirm or deny participation in the presentation using a dialog-box type user-interface. If a section was previously associated with the presentation, e.g. by acquisition of published materials, this section is used (opened) rather than creating a new one. The existence of a section can be accomplished by checking if any existing section is already associated with the unique presentation ID assigned to a presentation. Alternatively or additionally, event and timing information is communicated from a presentation viewing tool running on the note taker's computer. For example, the notes module may communicate directly with a viewer of a TSA component if one is running concurrently on the note taker's computer, or with a remote server component otherwise, to obtain this information.

All pertinent events that occur on the systems of presenter and on note-takers are time-tagged. For a presenter, system events include, but are not limited to, the start (beginning) and stop (ending) of a presentation, pausing, resuming, slide changing, and bookmark creation. For a note-taker's system the events include, but are not limited to, insertion of a note, an iconic indication, or any other object related to a note. Time tags (or timestamps) are numeric values based on coordinated universal time (UTC) which is the same as Greenwich Mean Time (GMT). Computer clocks may not be set to the accurate time and each clock is limited in its precision, typically to 5-15 seconds a day. For that reason, it is important that all the UTC timestamps be synchronized to a common time server.

Each computer has a system-wide clock, also known as a system clock, which a user may view and change. During the act of synchronizing to the time server the system clock is adjusted so that timestamps are subsequently obtained directly from it, however, this is not required. Instead, in accordance with the invention an offset value is stored. This offset value allows the effective computing of a UTC timestamp from a system clock value, as described in greater detailed below.

Unlike prior art that synchronizes the presenter's system and note-takers' systems to each other online, the invention maintains reasonable synchronization without requiring a constant, active connection. Specifically, the systems of the presenter and note-takers are not required to communicate with each other, nor with any other systems during the presentation. The presenter system and all note-takers' systems communicate with the time-server 860 periodically for the purpose of synchronization, a process described herein below.

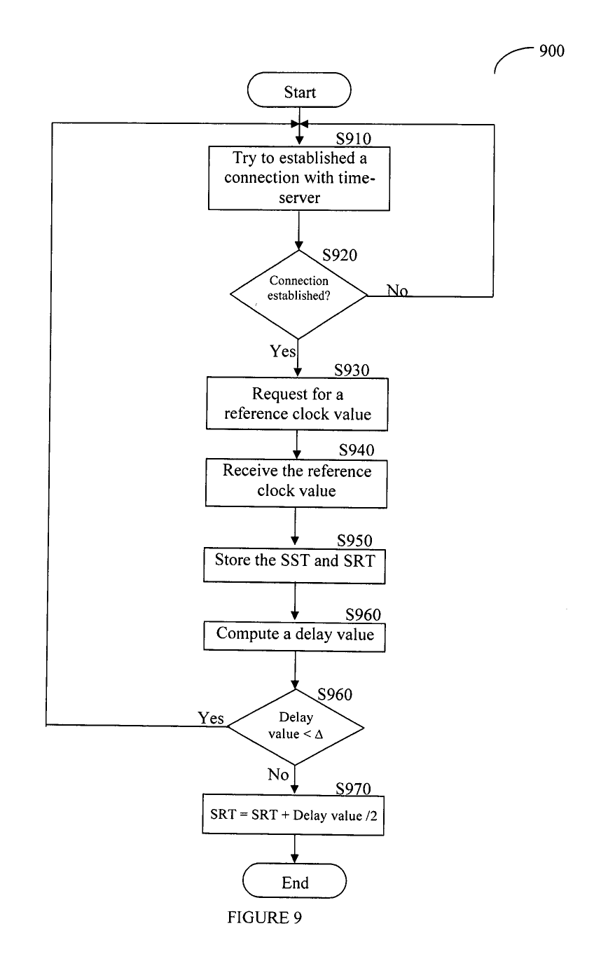

Referring to FIG. 9, a non-limiting flowchart 900 describing the clock's synchronization process is shown. Each of the handheld devices 850, computers 840, or computer 820, used by the presenter or the note-takers, and collectively referred to herein as synchronization clients, executes the synchronization process. At step S910, each synchronization client periodically tries to connect to the time-server 860. This step is performed at pre-configured time intervals or whenever the computer is turned on. At step S920, a check is made to determine if a communication with the time-server 860 was established and, if so, execution continues with step S930. Otherwise, execution returns to step S910. At step S930, a request is sent to time-server 860 requesting the current value of the reference clock. At step S940, the time-server 860 responds with the desired value and subsequently, at step S950, the time values are stored. Specifically, two time values are kept: a stored system time (SST) and a stored reference time (SRT). The SST is the system clock value of the synchronization client at time of synchronization. This time is read after receiving the server's response. The SRT is the reference clock value (UTC) at time of synchronization as designated in the response. At step S960, the delay between the time that the request was sent and the time that the response received is measured, to reduce inaccuracy results from communication delays. At step S970, a check is made to determine as to whether the computed delay is less than a pre-configured value (A). If so, half of the computed delay value is added to the SRT. Otherwise, the synchronization process is unsuccessful and execution returns to step S910, while restoring the SST and SRT values to their previous values.

Upon completion of the synchronization process, the computed SRT and SST values are used to derive a UTC timestamp. This is performed using the equation:
CRT=CST+SRT−SST (1)
where CRT is the current reference time and CST is the current system time.

It should be noted that the CST is vulnerable to changes by the user or a third party application, and thus results in an inaccurate timestamp value. To avoid this, the system clock is always monitored. This is performed by tracking a message generated by the operating system (OS) that notifies that the system clock was changed, for example, the WM_TIMECHANGE message generated by Microsoft Windows. Another option for monitoring changes in the system clock comprises the comparing of the CST to the tick-count. The tick-count value represents the number of milliseconds since the synchronization client system was first started. This value is read and stored in the system's memory. Periodically, the CST and tick-count values are read and compared to each other. If both clocks have advanced equally, then no change has occurred. Otherwise, the amount that the CST has advanced is accumulated into a stored value, referenced to as the advanced system time (AST).

The AST is set to zero each time the SRT and SST values are stored. Therefore, a correct UTC timestamp for any event may be computed by the following equation:
CRT=CST+SRT−SST−AST. (2)
Alternatively (or in addition), the note taker is allowed to create new sections manually and/or associate them with presentations before, during, or after the presentation by use of a presentation browsing and selection user-interface. The association can also be done by, or be assisted by, an automatic search through a collection of recorded presentations on specific servers, and selection of the one (or listing of those) that match appropriate criteria, among them the date and time-span in which the presentation took place. If clocks are not synchronized by either on-line or off-line approaches as described above, there remains the need to obtain a presentation base-time for proper synchronization. At least two additional options may be included to address this issue. One option is to allow note takers to correct the synchronization error after the presentation by shifting the time-frame values stored for the presentation while reviewing notes (described later). The second option is to have the notes module offer note takers a user interface, for example a button or recognizable pen gesture, that they can use when the presentation begins to reset the clock of the presentation, i.e. to indicate its starting time. The presenter is expected to notify participants when to activate this, for example by saying: “I'm starting now.” Presentation capture is expected to start simultaneously, as well by the presenter or an assistant. A similar arrangement can be used to stop the presentation. However, this is not strictly necessary because all timestamps beyond the end of the captured presentation can be ignored or otherwise dealt with automatically while reviewing the presentation later on.

The various synchronization options are implemented by a commonly applied user interface and communication techniques while storing a UTC timestamp for each note or storing an offset or base time per notebook section, i.e. per presentation on each note taker's computer, that can be set and adjusted as needed (internally and/or by the user) and to which all timestamps associated with that notebook section refer, via addition or subtraction, to produce timestamps that lie within the presentation time-frame, i.e. timestamps that are relative to the start of the presentation. Specifically, with current real-time clocks of personal computers and other note taking devices, their internal real-time clocks are accurate to 5-15 seconds a day. Therefore, it is not necessary to maintain an accurate, or on-line synchronization, at all times during the presentation. In accordance with the disclosed invention, the notebooks 850, computers 840 and 820, and the server 830 may synchronize clocks with a reference clock of a time server, for example time server 860, on a periodical basis, for example once every two days. At worst case this gives an accuracy of 30 seconds, which is sufficient for all practical matters. As computer clocks become more accurate it is possible to delay clock synchronization for longer periods of time. This frees note taking from the need to maintain on-line connectivity with the presenter's presentation and allows the taking of notes in an of-line but synchronized manner. This is of particular importance in lecture rooms, where a computer-based presentation is provided, but no network equipment is available to note takers.

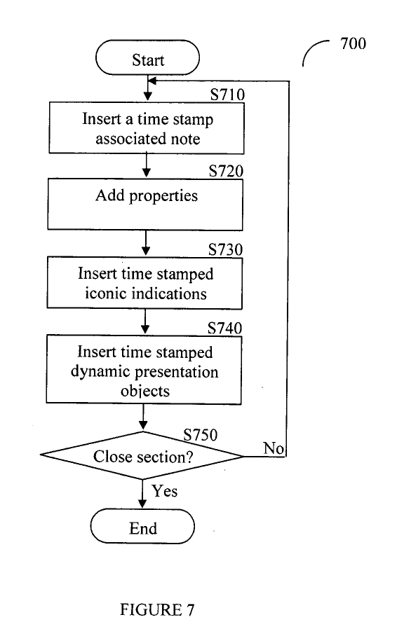

Referring to FIG. 7, a non-limiting flowchart describing the method for capturing notes and arranging them in accordance with an exemplary embodiment of the invention is shown. This method can be executed after the start event is received, the clocks were synchronized, and the presentation base-time value is set, either during the presentation, or after it while reviewing notes.

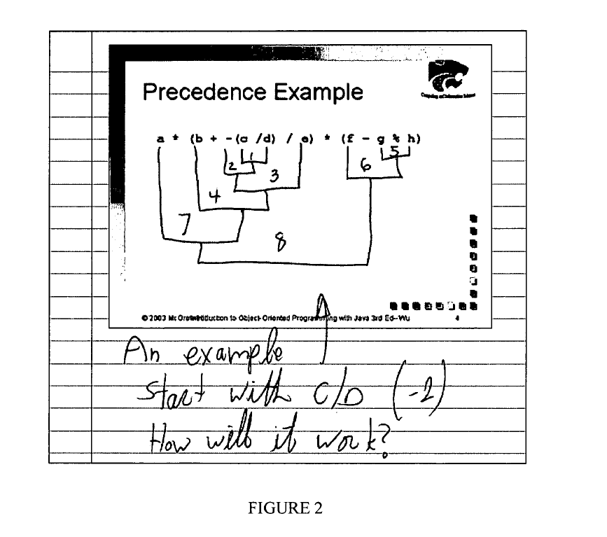

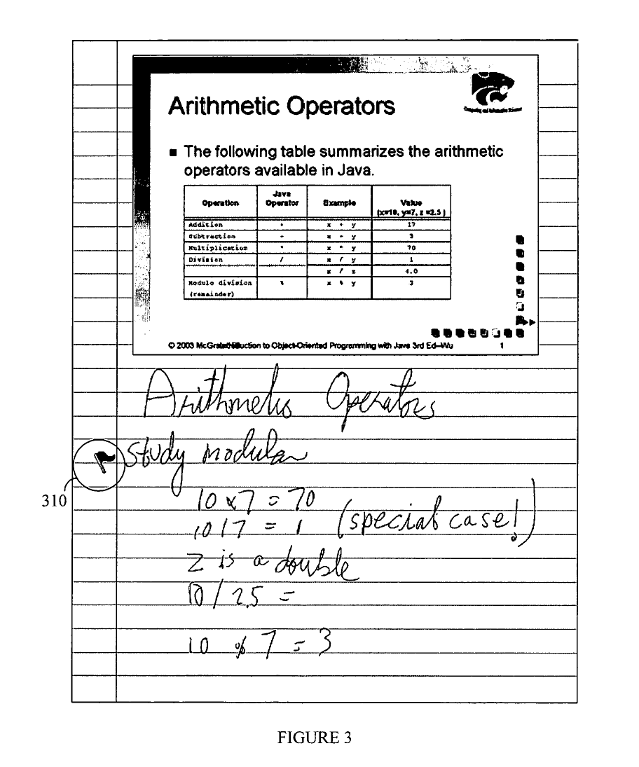

At step S710, each note taker enters time stamped notes in a notebook section before, during, or after the associated presentation. Notes may be inserted over an area on a page that has an empty background or with partial or full overlap over visible objects inserted in the notebook prior to, or during the presentation. For example, a student in a lecture may scribble hand-written notes using digital ink in the notebook application running on a portable tablet-based computer, such as a TabletPC. The student may have previously inserted an image of one of the instructor's slides and may now annotate over it, adjacent to it, or both. For example, a note taker may draw an arrow that points into the slide image while adding a written comment outside the area at the other end of the arrow, as shown in FIGS. 2 and 3. While these figures show note taking, where a slide from a presenter is included, this should not be understood as limiting the scope of the invention. Specifically, note taking may be performed regardless of whether a presentation is included or not as part of the note taking. The student may also type text and insert additional objects, for example subsequent slide images published by the instructor, if they are accessible either locally or via a network, and then annotate them in a like fashion. For the most part, these capabilities are provided by the underlying notebook application. The time stamp includes at least the current date and time, synchronized as explained in more detail above, and as obtained from the note taker's computer. The time stamp is not required to be in on-line synchronization with a time server, for example the time server 860, which is particularly convenient when a note-taker is taking the notes while the note taking device is off-line. This can usually be accomplished by adding a property or tag to newly added data, which is detected either by event notification, or by periodic scanning of objects, object Ids, or content. For implementations that do not support tagging objects or where impractical, a separate table is maintained to match object identification and timestamps. The absolute time stored for each note may be used in conjunction with the base-time, if one is stored, and possibly modified later, for each section that has a corresponding captured presentation. Notes for presentations that are not captured may still be time stamped to support time-based search, sorting and listing functionality during notes-review after the presentation. At step S720, additional properties may be added to assist in later identification and search operations. For example, the unique section ID, or equivalently the presentation ID, may be added if notes are not stored in hierarchical fashion under sections.

At step S730, the note taker may insert time-stamped iconic indications with predefined meaning anywhere on the page. For example, an iconic symbol that represents “need to review” may be inserted by the student mentioned above. A variety of iconic symbols may be offered for conveying other meanings, including but not limited to “action item,” “important,” “work assigned,” “further research,” and “missed portion.” For additional flexibility, note takers may be allowed to assign their own meanings to a subset of iconic indication symbols. After the presentation this facilitates locating points that were not well understood during the presentation and that therefore require review. For example, FIG. 3 shows an iconic indication 310 depicted by a flag inserted by a note taker to specify a point that merits further study. In this case, the note taker explicitly wrote alongside the indication a reminder to “study modula” (the modula operator). Multiple such types of indications may be predefined, and the list of these indication types, icons, and their meanings may be customized using commonplace user interfaces and data structures.

In addition, an inserted iconic indication may be associated with one or more notes that the note taker selects. This allows the note taker to insert private bookmarks on selected notes for use in later review. The insertion of icons and associating them with notes may be implemented in a straightforward manner in the notes module with user interface techniques that are well known to those who are skilled in the art. These techniques include, but are not limited to, object insertion (as discussed above) and storing tags or a table with the appropriate association of object identifiers. The iconic indication may be given a fixed visual appearance at its insertion point on a notebook page. Iconic indications of the private-bookmark variety can instead be shown temporarily as a visual icon when an associated note is selected or highlighted by the note taker or automatically during notes-review, as described below. Another option allows automatically assigning a private bookmark to each object acquired from the material published by the presenter. For example, if the presenter published a collection of slides, and these are inserted by the note taker, this option may assist the note taker in a later review of the presentation.

At step S740, the note taker, having appropriate network connectivity, may insert time-stamped dynamic presentation objects to his notebook. A dynamic presentation object is selected and inserted any other material from a known online location. It may be, for examples the link pre-published by the presenter for online viewing (described above). Unlike static objects, such as images or text, the dynamic presentation object represents a dynamically changing view of the presentation, which continues to change while embedded in the note taker's notebook. The specific content of this view varies based on the presentation capture technology, but in general it contains changing multimedia content. This may be implemented, for example using technologies such as ActiveX, COM, and plug-ins, along with programmatic interfaces that could be standardized for communication between such embeddable components and presentation capture applications.

In an embodiment of this invention, the presenter uses a TSA to capture the dynamic presentation objects. In this case, the visible appearance of the dynamic object includes the current slide, computer-display of the presenter, or snapped images from external cameras, together with annotations the presenter makes on a whiteboard or tablet surface. Optionally, the object may be positioned and resized by the note taker on the notebook page as desired. In this mode the object continues to change as the presenter makes further annotations or when the background changes. However, the invention could be configured to freeze the dynamic object's appearance once the presenter moves on to another distinct multimedia content item. This happens, for example, when the presenter advances to another slide, erases annotations, or switches to another source of visual input, e.g. a camera or a computer application. The notes module can communicate with a server component, for example a server 830 or a TSA, to obtain the required notifications. The note taker may add notes to this object as to any other, with or without partial or full overlap, both while it is dynamically changing and after it has frozen.

At step S750, it is checked whether the insertion process is complete and, if so, the session ends. Otherwise, execution continues with step S710. Any order of insertion is possible, and the order shown is for illustration purposes only. Moreover, not all types of insertions are necessary. For example, only notes or only objects can also be provided by the user of the system without departing from the scope of the invention.

Various options may be added based on the method discussed above. Specifically, the note taker may choose the dynamic presentation objects or static objects of the type he could have manually inserted before the presentation is auto-inserted, e.g. on a new notebook page, as the presenter advances through the sequence of multimedia content used throughout the presentation. As an example, when using a slide presentation each slide is automatically inserted in the note taker's notebook as the presenter displays it. The note taker then adds notes to it, and if the object is of the dynamic type, then annotation by the presenter or slide buildups appear as they are made. Another option is to allow note takers to freeze dynamic presentation objects manually whenever the note taker chooses to do so, in addition or instead of, using the auto-freeze option described above.

Another option is to allow automatic insertion of a special type of iconic indication referred to as a presenter bookmark whenever the presenter advances to the next in the sequence of multimedia content elements. In the above example, when the presenter advances slides, such bookmark indications are automatically inserted in a note taker's notebook, in addition to other multimedia objects that are inserted as well. Presenter bookmarks are useful during notes review.

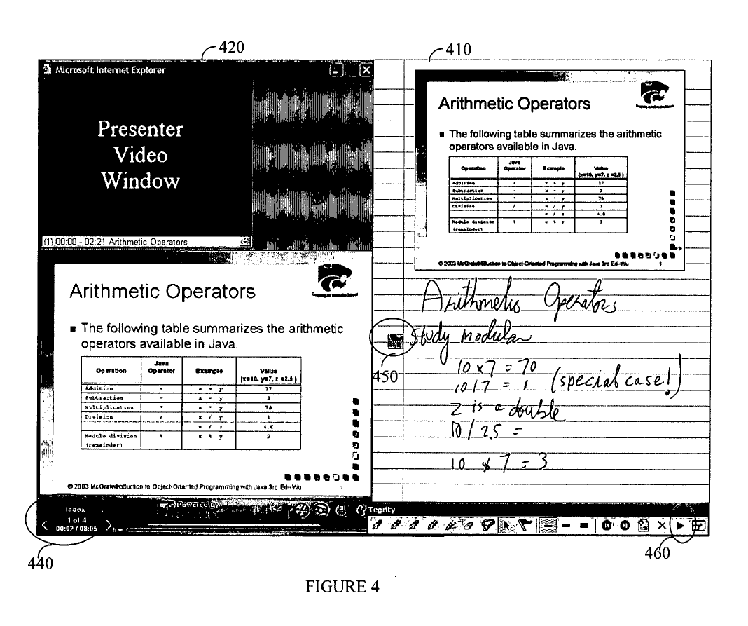

Further to the above, a participant that has network connectivity can perform the above actions while also viewing the presentation concurrently in a separate viewer application. This is especially useful for remote participants. FIG. 4 shows an example of a notebook application in section 410 together with a presentation viewing application 420. The content is displayed at time 00:02. An advanced application of this mode is based on synchronous collaboration tools offered by many prior-art presentation tools. This is best described by an example. In this example the presenter, an instructor, writes out a math problem while a participant, Joan, views the presentation remotely, using a presentation viewing tool. In addition, Joan has dragged a dynamic presentation object into her notebook where the instructor's writing also appears, in addition to the viewing tool and the private notes that Joan has written over this object. The instructor then requests that Joan solve the problem for the class and, using facilities of the presentation tools, temporarily makes Joan the presenter. Now, Joan writes the solution in the viewing tool and, while doing so, the writing also appears in the dynamic object within her notebook and, presumably, on the displays of other concurrent viewers and in the recorded media. Afterwards, the instructor takes back presenter privileges and clears the page, which may automatically freeze the appearance of the dynamic object that Joan has in her notebook. The display of this object within the notebook now includes the problem as written by the instructor, the solution as written by Joan in the role of temporary presenter, and additional private notes that Joan has written, e.g. “special case!” A variant of this, in which the implementation of the embedded dynamic object is enhanced with synchronous collaboration capabilities, allows Joan to solve the math problem directly in her notebook, rather than in the separate viewer application. While Joan has presenter privileges her new notes are made public, i.e. broadcast to other participants, while at other times they are private and stored only in her computer. Given software components that cooperate using a shared programmable interface, the implementation of this scenario is straightforward.

Given limited display space, various options may be offered to conserve such space when the note taker uses a presentation viewing tool concurrently with the notebook application. The window displaying the notebook application could automatically be resized to fit in the remaining display space. When a dynamic presentation object, which is presumably large, is concurrently active in the notebook, the viewing tool is automatically minimized because much of its content is superfluous at that time. Alternatively, the dynamic presentation object is temporarily replaced with an iconic representation thereof for as long as the viewing tool is synchronously operating and displayed. Once frozen, the object is restored to its full size. These options save display space while slightly impinging on the note taker's viewing or note-taking abilities. These tasks are accomplished in the notes module and/or the presentation viewing tool with commonly used interfaces for manipulation of display windows and object visibility, size, or format within the notebook application.

Note takers may use note-taking devices such as the Pegasus Mobile Note Taker® to capture their notes in digital form while using ordinary ink on a paper notebook. The device is capable of storing the positions of points that comprise strokes of ink as they are drawn on paper, along with the associated time-stamps, which can later be used to link the stored notes to the presentation. In addition, such a device may store events, such as clicking on virtual buttons, provided by sensitive areas on the device itself or predefined areas in its sensing region, which may be activated by the pen or by alternate means. These events, along with their associated time-stamps, can be used to implement the features of iconic indications and private bookmarks, as described above. This is accomplished by importing the stored notes and events at some later time, or as they are generated into the notebook application while converting the stored data to the internal representation used for the corresponding elements, e.g. notes, iconic indications, etc. Similarly, such an operation may be performed by using other NTDs or MM-NTDs as mentioned in more detail with respect to the disclosed invention.

All of the above may be done by participants that are physically located at the site of the presentation event, as well as by participants at various remote locations. The remote participants may view or listen to the presentation by any means of communication, whether computer-based, such as using a TSA. For example, an employee may listen to a meeting from home over the telephone while jotting down notes in a notebook. If he has network connectivity, he can insert a dynamic presentation object showing the current slide, along with comments and slide buildups that his manager adds to the display as the meeting progresses. When moving on to the next topic and slide, the object's appearance freezes, and the employee can choose to insert a new dynamic object elsewhere in his notebook.

The following is a detailed example for processing and reviewing notes after a presentation. Notes are useful in review after the presentation. An important benefit of the invention is achieved when reviewing notes for recorded presentations that are accessible to the note taker's computer, either online or on local media. The following describes post-presentation capabilities that can be supported by the invention for such presentations.

Asynchronous note capture. The note taker may insert new notes and iconic indications into a notebook. This operates in a similar manner as during the presentation, but lacks support for functions that are based on synchronous operation, e.g. dynamic presentation objects. In this mode, new notes are assigned a timestamp that corresponds to the relative time within the presentation as determined by the current playback position. By inserting these notes in the time-frame of the presentation they behave as if they were created during the presentation for the functions described herein. This is accomplished as with notes that are created during the presentation, with a difference being that the notes module communicates with the presentation viewing tool to obtain the current playback time for use in calculating the timestamp to be stored with the notes. In addition, such notes may be specially tagged as review notes, which can be useful for advanced note searching, listing, or sorting functions. Notes added to a presentation's notebook section while the presentation is not being played back are similar to notes added to it before the presentation took place. They may be assigned to the presentation's start time or any time outside the time-frame of the presentation. If such notes can be identified within the notebook section of an existing presentation they are still associated with that presentation.

Indexed playback. The note taker may review notes asynchronously. Where desired, he may select a note, an iconic indication, e.g. private bookmark or presenter bookmark, or any inserted object that is associated with a presentation timestamp. By clicking a button, using a pen gesture, or by some other user-interface element, the note taker can activate instant playback of the appropriate recorded presentation from the point at which the note was entered. This automatically opens the corresponding viewing tool with the appropriate media for that presentation, positions playback to the correct relative time within the presentation, and begins playback.

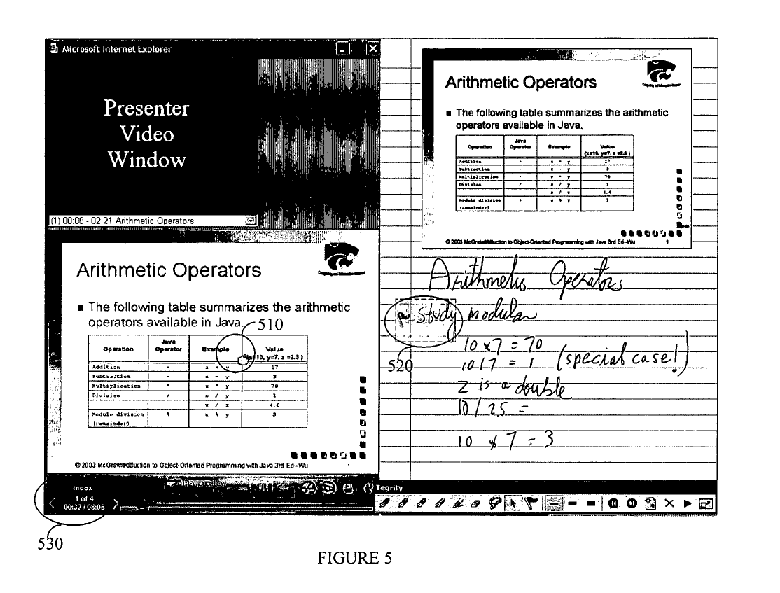

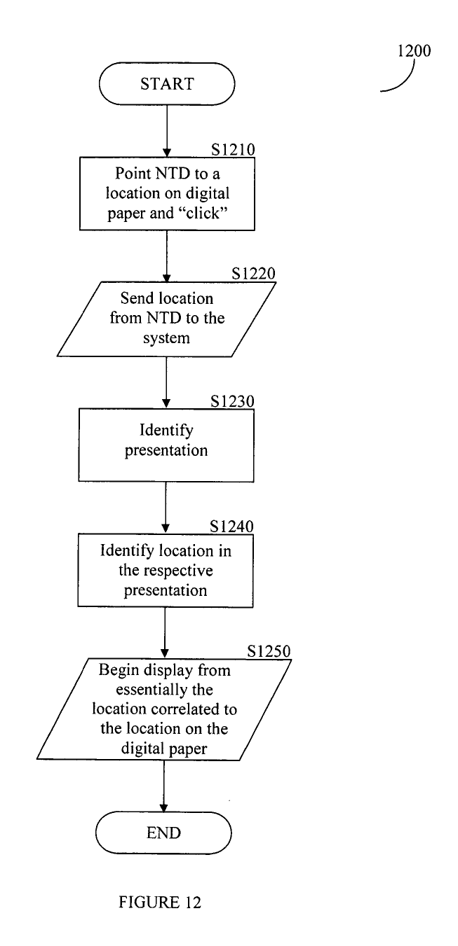

FIG. 4 and FIG. 5 depict an example of indexed playback. FIG. 4 shows both the notebook and viewing applications after the iconic indication, the flag 450, has been selected by the note taker. This selection is made when the viewing application is already running and displaying the first few seconds of the presentation, as indicated by the time 0:02 shown in section 440. After the note taker clicked the “play” button 460 the viewer application, as shown FIG. 5, is automatically positioned to time 0:32, as shown in section 530, and proceeds to playback the presentation from there. This is the point in the presentation during which the note taker had originally inserted the iconic indication. An iconic “hand” 510 can be seen over the slide image indicating where the instructor was pointing at that time. Audio, video, presenter annotations, and other data streams proceed to playback continuously from this point as well. Another example is provided with respect of FIG. 12, where the use of a note-taking device in conjunction with digital paper is shown.

Notes for a presentation that do not have a timestamp in the time-frame of the presentation optionally playback from the beginning of the recorded presentation or open the viewing tool in a paused state. This includes notes made within the notebook section associated with the presentation prior to the presentation, and notes made after it without presentation playback. Indexed playback is not available on notes unassociated with recorded presentations. This is indicated and enforced by hiding or disabling the activation button 460 or other user-interface element if it is always visible, or using a button or element that dynamically appears only when playable notes are selected. Rather than, or in addition to, using the note's timestamp to determine the playback point, the latter may be determined by using a time that is n seconds earlier or the start of the previous presenter-bookmark, the later of the two, or other logic that considers the timestamps and captured objects. The user is allowed to modify the value of n or other aspects of the logic in this case. Playback times are calculated on the fly or taken from a pre-computed table with entries for each playable object. This is especially useful when complex logic is used to determine optimal playback time.

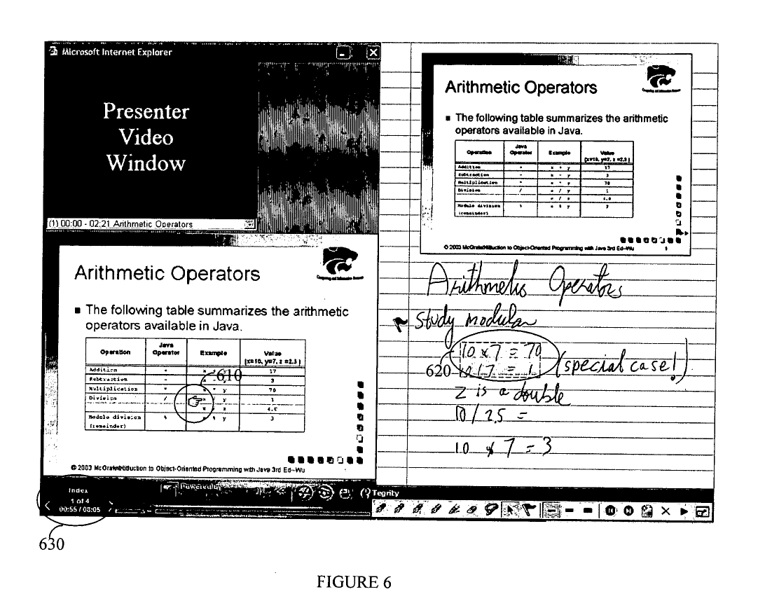

Note highlighting. When playing back recorded presentations, or any portions thereof, with the associated viewing tool, the current note, if any, may be highlighted by displaying it as selected or by varying one or more of its formatting attributes. The current note is defined as the latest note or other object created on or before the relative presentation time corresponding to the current playback time. The notebook application in FIG. 5 shows in section 520 how the iconic indication (the flag) and an adjacent note (study) are highlighted during the playback at time 0:32 that resulted, in this case, from indexed playback of the selected icon as described above. FIG. 6 shows the change that occurs 23 seconds later, i.e. at time 0:55, shown in section 630. As seen in this example, the highlighted appearance shifts from one note, displayed in section 520 of FIG. 5, to the next note, displayed in section 620 of FIG. 6, to match the timing and order in which the notes are created with respect to the presentation either as it was given or during review.

Note-highlighting uses the same logic as for indexed playback, whereby highlighting may occur a certain modifiable number of seconds prior to, or after, the actual timestamp or with consideration of bookmark times. Normally, one note is highlighted at a time, although it is not difficult to allow a specific number of notes to remain highlighted simultaneously, for example the previous, current and next note perhaps with different formatting for each, such as fade-in and fade-out or all notes within a specific duration, for example, the past five minutes. A time limit may also be set to turn off highlighting of a note once the time limit expires. Turning off highlighting causes a note to resume its former appearance. A variant of this feature allows replaying the note-taking activity. The notebook section could be shown empty when starting presentation playback, and subsequently, each note appears in it at the relative time corresponding to when it was written. Navigating the viewing tool to a different point in the presentation causes the notebook appearance to change to reflect all notes that appear at the corresponding time. These options could be implemented by the notes module, which communicates with the viewing tool to obtain the current playback time and match it with a pre-computed table, sorted by time, with entries for each note or object that may be highlighted.

Iconic indications. The note taker may request a summarized listing of the iconic indications in the notebook, or a section thereof. If multiple types of indications are defined, this may apply to a selected one or subset of types. Indications may also be selected by time range. A list of results are presented, showing the context of the iconic indication as a thumbnail image of the page or area in the notebook or a slice of the page. The display may also show the relative time within the presentation, as well as other pertinent details that may have been stored by the notebook application for the presentation, such as its title, name of presenter, etc. The display also shows the iconic indication for each entry. The note taker clicks on this to activate instant playback of the appropriate recorded presentation from the required point, as described above for indexed playback. The notes module performs the tasks of searching and displaying, assisted by stored tables of indications, including timestamps, type, notebook section, position (page), etc.

Private notes indication. The presentation viewing tool may allow viewing of a summary index of a recorded presentation. This may include thumbnails images of the presenter's slides, for example, or other summary information. When showing this display to each note taker it also provides visual indication of portions of the presentation for which the note taker has notes in his notebook. Specifically, the index-view of a TSA shows a small thumbnail image for each presenter bookmark, which corresponds to a portion of the presentation, and allows playback thereof. With respect to each of these portions for which the note taker has notes, the thumbnail image contains a small distinctive indication, either a special mark or other visual formatting element. This assists the note taker in searching for notes within the presentation and accessing them. A TSA obtains the necessary information to implement this by communicating with the notes module. In a similar fashion, other displays and lists may be enhanced with information about existence of notes, provided the appropriate programmatic interfaces are added to support this. For example, an organizational LMS, or the like thereof, could integrate such information into the displays that it provides.

Time adjustment. In some scenarios, as described earlier, there may be improper synchronization between notes and the corresponding viewable presentation media. The note taker may be offered a user-interface to adjust the base-time for a notebook section corresponding to a recorded presentation. The user interface could be a slider that is used while playing back the presentation recording to correct obvious timing mismatches. Alternatively, an edit box may be offered to enter a date-time or time offset value to apply. Another option is to allow the user to select a note while playing back the presentation and let him activate a set time function which modifies that note's time to correspond to the current playback position and shifts all other notes' timestamps accordingly. The implementation of these is straightforward and relies on using a single base or offset time per notebook section to be used in all time calculations, as described earlier.

Note copy. Copying notes within the notebook application, or from one notebook application to another, retains the added properties that support the capabilities of the invention. To support interaction with external applications, including other implementations of notebook applications, may necessitate using options for importing and exporting note data while performing appropriate format conversions. A specific example of this involves support for devices that do not run full-fledged notebook applications. Some handheld devices may require development of special-purpose note-taking applications with only a subset of the functionality described above. Import and export functions allow data to be exchanged with such devices. For example, a note taker may maintain a fully functional notebook application on a computer at home, but attend classes or meetings with a handheld device of limited functionality. The handheld device could be loaded with pre-presentation information from the home computer and presentation-time data could subsequently be transferred back to the home computer, where the user employs the post-presentation reviewing functionality. As another example, the note taker's home computer may not have a notebook application at all. Yet the note taker may still want to benefit from the material published prior to the presentation while using a handheld device. In this case, a separate tool is provided to perform the acquisition of published material and export it to the handheld device. These operations can be implemented using data processing techniques commonly known in conventional programming.

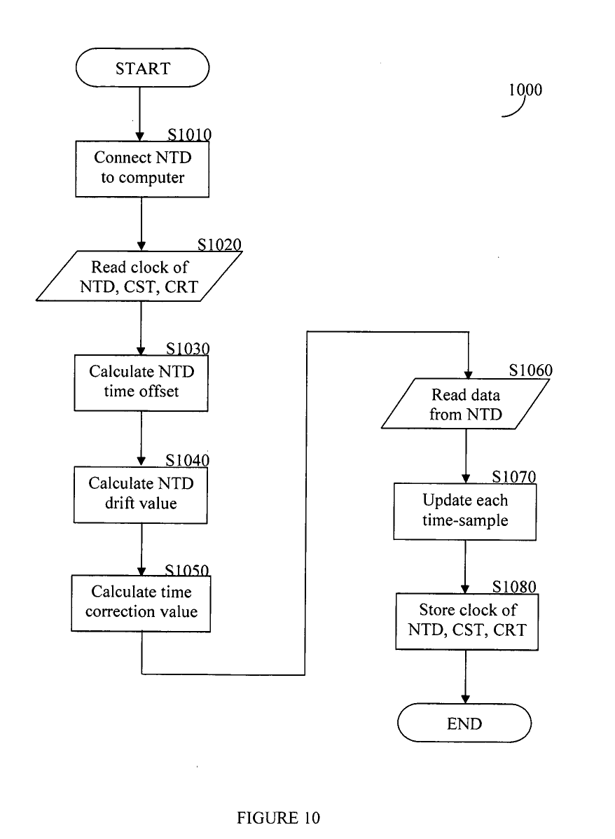

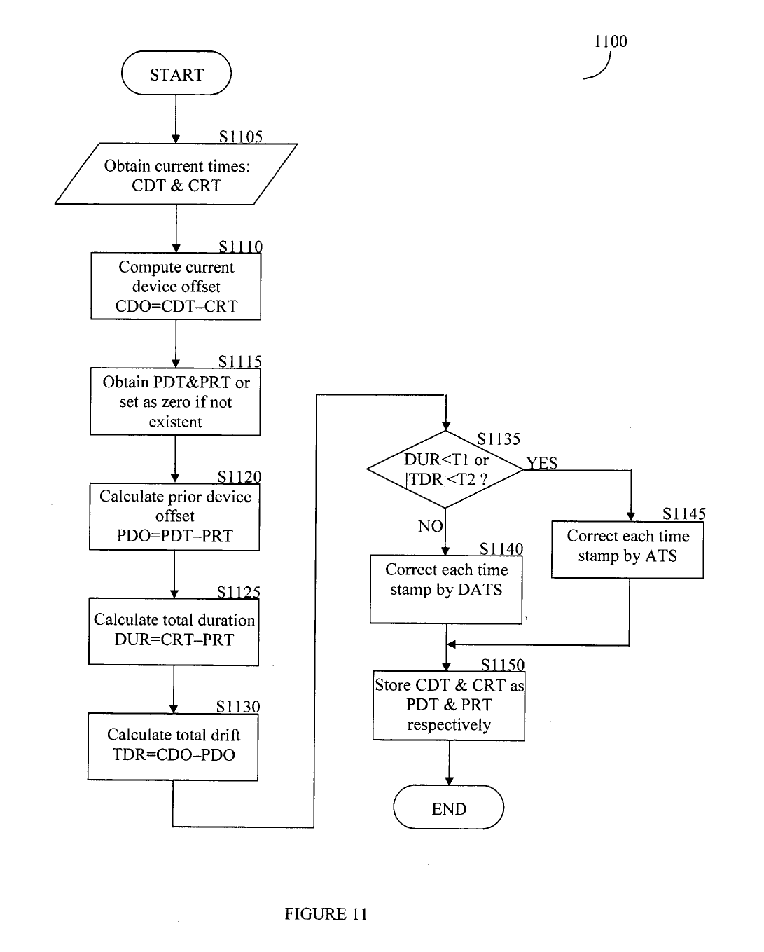

As noted above, various additional functions may be added as conveniences to the note taker, e.g. for adjusting settings and operational parameters or entering, modifying, and manipulating attributes and other data. In one embodiment of the disclosed invention, it is necessary to synchronize the note-taking device's clock with the current reference time CRT, detailed above with respect to Equations (1) and (2). Reference is now made to FIG. 10, where an exemplary and non-limiting flowchart 1000 shows a method for synchronizing the clock of a note-taking device (NTD), the NTD explained in more detail above, to a CRT. A specific example of the calculation suggested herein is discussed with reference to FIG. 11, herein below. In step S1010 NTD, for example NTD 870-1, is connected to a computing device, such as a computer 840 or 850, described in more detail above. The link can be a wired or wireless link of any sort. In step S1020 the clock of the NTD is read, as well as the current system time (CST) and the current reference time (CRT), both of which were explained in greater detail above. It should be noted that in one embodiment, the clock of a NTD can be further updated periodically to be essentially equal to the reference clock or system clock, allowing for storing of less time information. In step S1030, an offset value between the NTD clock and the reference clock is calculated and stored for further use. In step S1040, a drift value, for example a drift rate, between the reference clock and the NTD clock is calculated. In one embodiment of the disclosed invention, the calculation of a drift value is optional. In step S1050, a time correction value is calculated based on the time-offset calculated in step S1030, and the drift value calculated in step S1040. In step S1060, data stored in the NTD, for example NTD 870-1, are transferred to a computer 840 or 850, for example, computer 850-1. In step 1070, the time stamps are adjusted in accordance with the time correction value calculated in step S1050. In step S1080, the values of the NTD clock, CST and CRT are saved for use in the next cycle of synchronization.

Using the disclosed method facilitates portability of the information stored in the NTD, for example NTD 870-1, such that it can communicate with a first computer, for example computer 840-1, and further being capable of transferring data and communicating with a second computer, for example computer 850-1, which may have different offset and drift parameters with respect to NTD 870-1.

In another embodiment of the disclosed invention, the offset and drift values are stored in the NTD, for example NTD 870-1, and the NTD is further responsible to update the time sample values in accordance with these values.

In yet another embodiment of the disclosed invention, the offset and drift values are periodically updated and a model is developed to allow for more advanced non-linear models of drift update.

In one embodiment of the disclosed invention, the time-drift between any two sampling points may be calculated as a linear function between the two sampling points.

In another embodiment of the disclosed invention the time-drift is calculated as a non-linear function over a plurality of sampling points.

Reference is now made to FIG. 11, where an exemplary and non-limiting flowchart 1100 for synchronizing between a reference clock CRT and a NTD clock is shown. In step S1105, the current NTD time CDT is obtained from the device and CRT is computed as described above with respect to Equations (1) and (2). In step S1110, the current device offset CDO is calculated as:
CDO=CDT−CRT (3)
where CDO may be thereafter applied for each writing stroke time imported from a NTD, for example NTD 870-1. In step S1115, the prior NTD time PDT and prior reference time PRT, are obtained. These values are initially set to zero, and updated thereafter, as shown in step S1150 below. In step S1120, the prior NTD offset PDO is calculated as:
PDO=PDT−PRT (4)
In step S1125, the total duration DUR is calculated as:
DUR=CRT−PRT (5)
In step S1130, the total NTD drift TDR from CRT is calculated as:
TDR=CDO−PDO (6)
In step S1135, it is checked whether the value calculated for DUR in step S1125 is smaller than a first threshold value or if the absolute value of TDR calculated in step S1130 is smaller than a second threshold value. The first threshold value may be, for example, 3,600 seconds. The second threshold value may be, for example, one second. If the answer for step S1135 is affirmative, then the time drift is not taken into account and execution continues with step S1145. Otherwise, it is necessary to take the time drift into account and execution continues with step S1140. In step S1140, the drift rate is determined as:
DR=TDR/DUR (7)
A person skilled in the art would note that the value of DR may also be calculated by using the following calculation:
DR=(CDT−PDT)/(CRT−PRT)−1 (8)
Then, as part of step S1140 each time stamp TS is adjusted resulting in the following drift adjusted time stamp DATS:
DATS=TS−CDO+(TS−CDO−CRT)*DR (9)
Hence, in this step both the time offset influence on the time stamp as well as the time drift influence is included in the time stamp adjustment process. In step S1145, each time stamp TS is adjusted only for time offset, each time stamp having an adjusted time stamp ATS as follows:
ATS=TS−CDO (10)
In step S1150, the values of CDT and CRT are stored as the values PDT and PRT, respectively, for the future use as explained above with respect of step S1115.

Another aspect of the use of a note-taking device respective of indexed playback discussed hereinabove, and more specifically, a note-taking device that operates like, for example, the pens mentioned hereinabove, is use of pen operation for controlling the system, and in particular a computer, for example one of computer 840 or 850, coupled through some communication means to the note-taking device 870, for example note-taking device 870-1. As noted above, in some cases the digital paper notebook provides, for example, without limitations via means of optical recognition, data concerning the location on a page where the note-taking device touches. Hence, in an on-line mode it is possible to indicate to a computer, for example a computer 840 or 850, of a system, for example system 800, where in a digital paper the note-taking device has touched. As each page of the digital paper notebook is uniquely identifiable, a specific link between the digital paper notebook and any location therein to the presentation may be created. Specifically, when touching a location on a page of a digital paper notebook, it is possible for a computer, for example computer 840-1 of system 800, to locate the presentation and the closest point, in space or time, within the presentation to which the notes written in proximity to that location on the digital paper relate. As a result, synchronization between the presentation and the location on the notebook may be achieved and, hence, the presentation reviewed by the user, enabling the review from the exact point in the presentation where the note was taken.

Reference is now made to FIG. 12 where an exemplary and non-limiting flowchart 1200 shows the operations of a computer, for example computer 840-1 of system 800 for enabling a click on a digital page for the purpose of note and presentation correlation. In step S1210 the NTD, for example NTD 870-1, is caused to point to a location on the digital page and collect the location information. Activation of this feature may be done, for example, by making a marking, pressing on an appropriate button on the note-taking device, or another appropriate means of activation. In step S1220, the location information is transferred to a computer, for example computer 840-1 on system 800, to which NTD 870-1 is coupled to. In one embodiment of the disclosed invention, the digital paper and/or the NTD is capable of causing the digital paper to be viewed as comprising of a plurality of stripes and only the location of the stripe is actually sent to the computer, for example computer 840-1. One advantage of this approach, while seemingly less accurate, is that it sends less data for this operation while still bringing the user of the note-taking device, for the purpose disclosed herein, close enough to the location in the presentation. In one embodiment, the location information of each stripe and other related information to the specific presentation, such as the time that the stripe was first accessed for the purpose of note-taking, are kept in the note-taking device NTD. Then, when access as a result of a click on a location in the page is performed to retrieve the position in the lecture, the stripe information in the note-taking device is used to cause such access on a computer, for example computer 840-1. Therefore, a click on the digital page is converted to a time point respective of the reference clock, allowing the system to associate the click with a specific presentation and a location at least approximately to a point in the presentation corresponding to the location in the digital paper. One advantage of this approach is that the time value required for retrieval of the presentation and of the point from which it is displayed, is supplied directly by the NTD and does not require that the computer 840-1 have access to stored notes or other stored information pertaining to the notes. In another embodiment, the coordinates of the location are used to identify a writing stroke, previously stored from the digital page used, and that is the closest to the point for which the note taking device was actuated. Once that closest writing stroke is identified the respective point in the presentation may be identified, for example as described above for indexed playback.

Returning now to FIG. 12, in step S1230 the presentation is located, for example by a time value which is either provided by the NTD or otherwise generated by the computer from the value received from the NTD. Other information may be necessary for specific point location, such as digital pen identification, user identification, and the like, and as further discussed herein. In step S1240, the closest point within the respective presentation to the location or stripe clicked upon on the digital paper is identified. In step S1250, the presentation is displayed from the location, or approximately thereof, on display means, for example the display means of a computer 840 or 850, preferably on the computer to which the NTD, for example NTD 870-1, is coupled.

The values in the text and figures are exemplary only and are not meant to limit the invention. Although the invention has been described herein with reference to certain preferred embodiments, one skilled in the art will readily appreciate that other applications may be substituted for those set forth herein without departing from the spirit and scope of the invention. It should be further noted that the methods disclosed herein may be implemented as part of a computer software product, the product containing a plurality of instructions that combined cause the operation of the methods disclosed here. Such computer software product may be, but is not limited to, on a disk, compact disk (CD), digital video disk (DVD), delivered over the Internet in an executable or compilable format, and the like. The innovation herein may be further implemented in hardware, firmware, and any combination thereof, including, but not limited to, the adaptation of existing devices, such as a NTD, to be enabled to perform the teachings herein. Accordingly, the invention should only be limited by the claims included below.

1. An apparatus for time synchronization of a presentation delivery system and notes taken by a note-taker, comprising:
means for providing said presentation to at least the note taker;
means for taking of notes of said presentation provided by said presentation delivery system by time-tagging a location of a paper notebook, wherein said time-tagging is relative to a clock associated with said means for taking of notes; and
means for synchronizing a reference clock associated with said presentation delivery system with said clock associated with said means for taking of notes;
wherein said means for taking of notes operates with respect to said clock associated with means for said taking of notes during an interval when note-taking occurs.

2. The apparatus of claim 1, wherein said presentation comprises any of:
audio, video, slides, notes, images, computer applications, pointing position, references to electronically accessible textbooks, articles, Internet resources.

3. The apparatus of claim 1, wherein said means for taking of notes comprises any of:
means for capturing writing strokes, means for capturing audio, and means for capturing video.

4. The apparatus of claim 3, wherein said means for capturing writing strokes further comprises:
a digital pen.

5. The apparatus of claim 4, wherein said paper notebook comprises:
digital paper.

6. The apparatus of claim 1, wherein said means for synchronizing further comprises:
means for calculating a time correction value based on a calculated time offset between said reference clock and said clock of said means for taking of notes; and
means for adjusting time tags of said time tagged data stored in said means for taking of notes, said time tags being adjusted in accordance with said time correction value.

7. The apparatus of claim 6, wherein said time tagged data comprise:
data corresponding to a writing stroke.

8. The apparatus of claim 6, wherein said means for a time correction value further comprise:
means for determining a time drift between said reference clock and said clock of said means for taking of notes.

9. The apparatus of claim 5, further comprising:
means for starting a presentation to appear from a proximate point associated with a selected location on said digital paper.

10. The apparatus of claim 9, further comprising:
means for receiving information from said means for taking of notes respective of one stripe of a plurality of stripes proximate to said selected location; and,
means for displaying said presentation notes written inside said stripe.

11. A method for synchronizing a note taking device and a presentation delivery system, comprising the steps of:
reading current values of a clock associated with said note taking device and a reference clock associated with said presentation delivery system;
calculating a time correction value based on an offset value between said reference clock and said note taking device clock;
reading data elements from said note taking device; and
adjusting a time tag of each said data element in accordance with said time correction value;
wherein said note taking device operates with respect to said note taking device clock while note taking occurs.

12. The method of claim 11, wherein said step of calculating a time correction value further comprises the step of:
calculating a time drift value between said reference clock and said note taking device clock.

13. The method of claim 12, further comprising the step of:
computing said time-drift value in a linear fashion between two sampling points.

14. The method of claim 12, further comprising the step of:
computing said time-drift value as a non-linear function over a plurality of sampling points.

15. A method for synchronizing a note taking device and a presentation delivery system by use of time stamps, the method comprising the steps of:
obtaining current note taking device time from said note taking device;
obtaining current reference time from said presentation delivery system;
either of obtaining previous note taking device time and the previous reference time, or setting said previous note taking device time and said previous reference time to a predefined value;
correcting each time stamp by a calculated time offset value;
storing said current note taking device time as the previous note taking device time; and
storing said current reference time as the previous reference time.

16. The method of claim 15, further comprising the step of:
correcting each time stamp by a value based on a time drift between the clocks of the note taking device and the presentation delivery system.

17. The method of claim 16, further comprising the step of:
computing said time drift value in a linear fashion between two sampling points.

18. The method of claim 16, further comprising the step of:
computing said time drift value as a non-linear function over a plurality of sampling points.

19. A computer software product for synchronizing a note taking device and a presentation delivery system, the computer software product containing a plurality of computer instructions that comprise a method for executing the steps of:
reading a current value associated with a note taking device clock and a current value of a reference clock associated with said presentation delivery system;
calculating an offset value between said reference clock and said note-taking device clock;
calculating a time correction value based on said time offset value with regard to said reference clock of;
reading data elements from said note taking device; and
adjusting time tags of each data element based on said time correction value;
wherein said note taking device operated with respect to said note taking device clock during an interval in which note taking occurs.

20. The computer software product of claim 19, said method further comprising the step of:
calculating a time drift value between said reference clock and said note-taking device clock.

21. The computer software product of claim 20, said method further comprising the step of:
computing said time drift value in a linear fashion between two sampling points.

22. The computer software product of claim 20, said method further comprising the step of:
computing said time drift value as a non-linear function over a plurality of sampling points.

23. A method for beginning the display of a presentation on a presentation delivery system from a desired point corresponding to a location on a digital paper by a note taking device, the method comprising the steps of:
associating said note taking device with a location on a digital paper;
actuating said note taking device to capture said location;
transferring said location to said presentation delivery system;
correlating said location with a point within said presentation; and
displaying said presentation from said point.

24. The method of claim 23, wherein said location is provided by the step of:
identifying a stripe from a plurality of stripes comprising said digital paper with which said note taking device is associated.

25. The method of claim 24, further comprising the step of:
storing in a memory of said note taking device said stripe location information and a time said note taking device was first used for note-taking.

26. The method of claim 23, further comprising the step of:
correlating actuation of said note taking device relative to said digital paper with a time point.

27. The method of claim 23, wherein the step of said correlating said location with a point comprises at least the step of:
finding the writing stroke stored for said digital paper that is closest to said location.

28. A computer software product for beginning the display of a presentation on a presentation delivery system from a desired point corresponding to a location on a digital paper by a note taking device, the computer software product containing a plurality of computer instructions that comprise a method for executing the steps of:
associating note taking device with a location on a digital paper;
actuating said note taking device to capture said location;
transferring said location to said presentation system;
correlating said location with a point within said presentation; and
displaying said presentation from said point.

29. The computer software product of claim 28, wherein said location is provided by the step of:
identifying a stripe to which said note-taking device is pointing from a plurality of stripes comprising digital paper.

30. The computer software product of claim 28, further comprising the step of:
storing in a memory of said note taking device said stripe location information and a time said note taking device was first used for note taking.

31. The computer software product of claim 25, further comprising the step of:
correlating actuation of said note taking device relative to a said digital paper with a time point.

32. The computer software product of claim 23, wherein the step of said correlating said location with a point comprises at least the step of:
finding the writing stroke stored for said digital paper that is closest to said location.
